(19) United States
(12) Patent Application Publication
(10) Pub. No.: US 2019/0023146 A1
(43) Pub. Date: Jan. 24, 2019

(54) BATTERY BALANCING DEVICE AND METHOD

(71) Applicant: LG Chem, Ltd., Seoul (KR)

(72) Inventors: Keunwook Lee, Daejeon (KR); Sang Hoon Lee, Daejeon (KR); Jun Cheol Park, Daejeon (KR); Yean Sik Choi, Daejeon (KR)

(73) Assignee: LG Chem, Ltd., Seoul (KR)

(21) Appl. No.: 16/070,457

(22) PCT Filed: May 11, 2017
(86) PCT No.: PCT/KR2017/004859

§ 371 Date: Jul. 16, 2018

(30) Foreign Application Priority Data
Jul. 29, 2016 (KR) 10-2016-0097478

(51) Int. Cl. B60L 11/18; H01M 10/44; H02J 7/00

(52) U.S. Cl. CPC B60L 11/1861; H01M 10/44; H01M 2220/20; H02J 7/0014; H02J 7/0026

(57) ABSTRACT

The present invention relates to an apparatus and a method of balancing a battery, and more particularly, to an apparatus and a method of balancing a battery, in which a control unit controls an operation of a balancing unit that performs balancing of a battery cell in response to a voltage value of the battery cell included in a battery, and an self-discharging unit discharges the battery cell according to whether the voltage value of the battery cell exceeds a predetermined first reference voltage value during a non-operation of the balancing unit.

### TECHNICAL FIELD

This application claims priority under 35 U.S.C. § 119 to Korean Patent Application No. 10-2016-0097478 filed on Jul. 29, 2016 in the Korean Intellectual Property Office, and under 35 U.S.C. § 365 to PCT/KR2017/004859 filed on May 11, 2017, the entire contents of which are incorporated herein by reference.

The present invention relates to an apparatus and a method of balancing a battery, and more particularly, to an apparatus and a method of balancing a battery, in which a control unit controls an operation of a balancing unit that performs balancing of a battery cell in response to a voltage value of the battery cell included in a battery, and a self-discharging unit discharges the battery cell according to whether the voltage value of the battery cell exceeds a predetermined first reference voltage value during a non-operation of the balancing unit.

### BACKGROUND

Recently, interest in an electric product, which can be driven by using a secondary battery, has increased due to depletion of fossil energy, and environmental pollution due to use of fossil energy. Accordingly, technology development and demands for a mobile device, an electric vehicle (EV), a hybrid vehicle (HV), an energy storage system (ESS), an uninterruptible power supply (UPS), and the like increase, and thus demands for the secondary battery as an energy source have sharply increased.

The secondary battery attracts attention as a new energy source that is environmentally-friendly and has improved energy efficiency in that it is possible to innovatively decrease use of fossil energy, which is the primary advantage, while not generating a by-product when using energy.

Particularly, a secondary battery used in an EV, an HV, an ESS, and a UPS is configured by connecting a plurality of battery cells in order to charge or discharge high-output and large capacity power. Battery cells of the secondary battery ideally need to have the same characteristic, but the battery cells have a deviation in capacity, impedance, and internal resistance, and the deviation increases according to the performance of a charging/discharging of the secondary battery. Due to the deviation between the battery cells, a specific battery cell is overcharged or overdischarged, so that a life of the battery cell is decreased, and further, there is a problem in that even a life of the secondary battery is decreased.

Accordingly, in order to improve stability and a life of the battery cell, a balancing technology for uniformly maintaining voltages of the battery cells is applied to the secondary battery. More particularly, the method of uniformly balancing a voltage of each battery cell included in the secondary battery includes active balancing which supplies a charging current to a battery cell having a relatively low voltage and increases the voltage, passive balancing which discharges a battery cell having a relatively high voltage and drops the voltage, and the like.

Particularly, in order to implement the passive balancing technology, a balancing circuit including a resistor consuming power of the battery cell, a switching element controlling electricity conduction between the battery cell and the resistor, and a control unit controlling on or off of the switching element according to a voltage of the battery cell is provided in the secondary battery.

However, in the existing balancing circuit, when the control unit is abnormally operated, the switching on/off of the switching element controlling electricity conduction between the battery cell and the resistor is not normally controlled and the switching element is not switched on when the discharging of the battery cell is required, so that there is a problem in that the battery cell is overcharged and a life of the battery cell is decreased, and even a life of the secondary battery is decreased due to voltage imbalance between the battery cells.

In this respect, in order to solve the foregoing problems, the present inventor invented an apparatus and a method of balancing a battery, in which a control unit controls an operation of a balancing unit that performs balancing of a battery cell in response to a voltage value of the battery cell included in a battery, and a self-discharging unit discharges the battery cell according to whether the voltage value of the battery cell exceeds a predetermined first reference voltage value during a non-operation of the balancing unit.

### SUMMARY

An object of the present invention is to provide an apparatus and a method of balancing a battery, in which a control unit controls an operation of a balancing unit that performs balancing of a battery cell in response to a voltage value of the battery cell included in a battery, and a self-discharging unit discharges the battery cell according to whether the voltage value of the battery cell exceeds a predetermined first reference voltage value during a non-operation of the balancing unit, so that even though the control unit has a problem, when the voltage of the first reference voltage value or larger is charged in the battery cell, it is possible to prevent the battery cell from being overcharged by discharging the battery cell.

An apparatus for balancing a battery according to the present invention includes: a balancing unit which is connected with a battery cell included in a battery and performs balancing of the battery cell; a control unit which controls an operation of the balancing unit in response to a voltage value of the battery cell; and a self-discharging unit which discharges the battery cell according to whether a voltage value of the battery cell exceeds a predetermined first reference voltage value during a non-operation of the balancing unit.

In the exemplary embodiment, the balancing unit may include: a balancing resistor consuming power of the battery cell; and a switching element which conducts or blocks a current flowing from the battery cell to the balancing resistor.

In the exemplary embodiment, when the voltage value of the battery cell is equal to or larger than a predetermined second reference voltage value, the control unit may switch the switching element to be on and allow a current to flow in the balancing resistor to discharge the battery cell.

In the exemplary embodiment, the self-discharging unit may be connected with the switching element in parallel, so that the voltage of the battery cell may be applied as an inverse voltage, and when the switching element is not operated, so that the voltage value of the battery cell exceeds the first reference voltage value, the self-discharging unit may electrically conduct the current flowing from the battery cell to the balancing resistor to discharge the battery cell.

In the exemplary embodiment, the self-discharging unit may be any one of a zener diode and a transient voltage suppression (TVS) diode.

In the exemplary embodiment, when the self-discharging unit is the zener diode, the first reference voltage value may be a breakdown voltage value of the zener diode.

A method of balancing a battery according to the present invention includes: providing ,which is connected with a battery cell included in a battery to perform balancing of the battery cell; controlling, by a control unit, an operation of the balancing unit in response to a voltage value of the battery cell; and discharging, by a self-discharging unit, the battery cell according to whether a voltage value of the battery cell exceeds a predetermined first reference voltage value during a non-operation of the balancing unit.

In the exemplary embodiment, the providing may include: providing a balancing resistor consuming power of the battery cell; and providing a switching element which conducts or blocks a current flowing from the battery cell to the balancing resistor.

In the exemplary embodiment, the controlling may include, when the voltage value of the battery cell is equal to or larger than a predetermined second reference voltage value, switching, by the control unit, the switching element to be on, and allowing a current to flow in the balancing resistor to discharge the battery cell.

In the exemplary embodiment, the discharging may include, when the switching element is not operated, so that the voltage value of the battery cell exceeds the first reference voltage value, electrically conducting, by the self-discharging unit, which is connected with the switching element in parallel, so that the voltage of the battery cell is applied as an inverse voltage, the current flowing from the battery cell to the balancing resistor to discharge the battery cell.

In the method of balancing the battery, the self-discharging unit may be any one of a zener diode and a transient voltage suppression (TVS) diode.

In the method of balancing the battery, when the self-discharging unit is the zener diode, the first reference voltage value may be a breakdown voltage value of the zener diode.

In the apparatus and the method of balancing a battery according to the present invention, the control unit controls an operation of the balancing unit that performs balancing of a battery cell in response to a voltage value of the battery cell included in a battery, and the self-discharging unit discharges the battery cell according to whether the voltage value of the battery cell exceeds a predetermined first reference voltage value during a non-operation of the balancing unit, so that even though the control unit has a problem, when the voltage of the first reference voltage value or larger is charged in the battery cell, it is possible to prevent the battery cell from being overcharged by discharging the battery cell.

### BRIEF DESCRIPTION OF THE DRAWINGS

FIG. 1 is a diagram schematically illustrating an electric vehicle to which a battery balancing apparatus according to an exemplary embodiment of the present invention is applicable.

FIG. 2 is a block diagram illustrating a configuration of the battery balancing apparatus according to the exemplary embodiment of the present invention.

FIG. 3 is a diagram illustrating an example of a particular configuration of the battery balancing apparatus according to the exemplary embodiment of the present invention.

FIG. 4 is a flowchart for describing a battery balancing method according to an exemplary embodiment of the present invention.

The present invention will be described in detail below with reference to the accompanying drawings. Herein, a repeated description, and the detailed description of a known function and configuration that may make the purpose of the present invention unnecessarily ambiguous will be omitted. Exemplary embodiments of the present invention are provided so as to more completely explain the present invention to those skilled in the art. Accordingly, the shape, the size, etc., of elements in the drawings may be exaggerated for a clearer description.

Throughout the specification, unless explicitly described to the contrary, when it is said that a specific part “comprises” a specific constituent element, it means that other constituent elements may be further included, not that other constituent elements are excluded.

In addition, the term “. . . unit” described in the specification means a unit for processing at least one function and operation and may be implemented by hardware components or software components and combinations thereof.

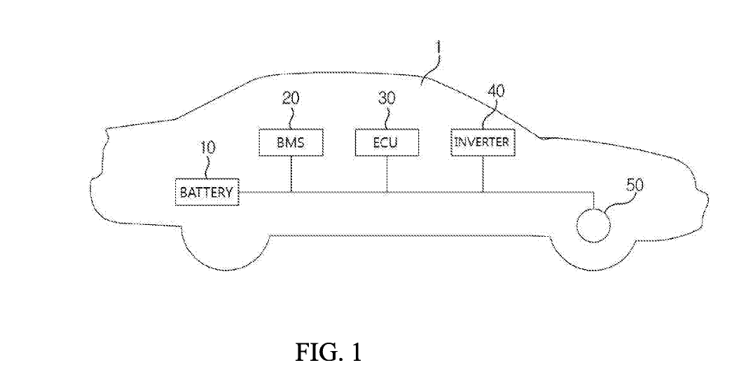

FIG. 1 is a diagram schematically illustrating an electric vehicle to which a battery balancing apparatus according to an exemplary embodiment of the present invention is applicable.

FIG. 1 illustrates an example, in which the battery balancing apparatus according to the exemplary embodiment of the present invention is applied to the electric vehicle, but the battery balancing apparatus according to the exemplary embodiment of the present invention is applicable to any technical field, such as a mobile device, an energy storage system, or an uninterruptible power supply, to which a secondary battery is applicable, in addition to the electric vehicle.

An electric vehicle 1 may include a battery 10, a battery management system 20, an electronic control unit (ECU) 30, an inverter 40, and a motor 50.

The battery 10 is an electric energy source which provides driving force to the motor 50 and drives the electric vehicle 1. The battery 10 may be charged or discharged by the inverter 40 according to the driving of the motor 50 or an internal combustion engine (not illustrated).

Herein, the kind of battery 10 is not particularly limited, and may include, for example, a lithium ion battery, a lithium polymer battery, a nickel cadmium battery, a nickel hydrogen battery, and a nickel zinc battery.

The BMS 20 estimates a state of the battery 10, and manages the battery 10 by using information on the estimated state. For example, the BMS 20 estimates and manages state information of the battery 10, such as a state of charging (SOC), a state of health (SOH), a maximum input/output power allowance quantity, and an output voltage, about the battery 10. Further, the BMS 20 controls a charge or a discharge of the battery 10 by using the state information, and further, may estimate a replacement time of the battery 10 by using the state information.

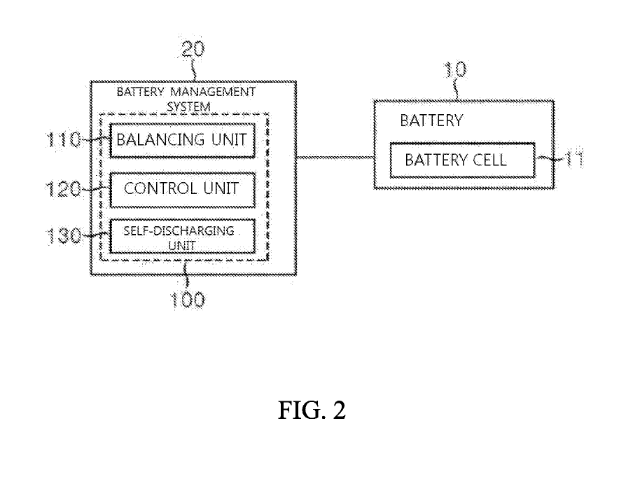

Further, the BMS 20 may include a battery balancing apparatus 100 (FIG. 2) which is to be described below. The battery balancing apparatus 100 may control an operation of a balancing unit which performs balancing of a battery cell in response to a voltage value of a battery cell included in a battery 100, and discharge the battery cell according to whether the voltage value of the battery cell exceeds a predetermined first reference voltage value during a non-operation of the balancing unit, thereby preventing the battery cell from being overcharged.

The ECU 30 is an electronic control device controlling a state of the electric vehicle 1. For example, the ECU 30 determines the degree of torque based on information, such as an accelerator, a break, and a speed, and controls an output of the motor 50 to be matched to the torque information.

Further, the ECU 30 transmits a control signal to the inverter 40 so that the battery 10 is chargeable or dischargeable based on the station information, such as an SOC and an SOH, of the battery 10 received by the BMS 20.

The inverter 40 allows the battery 10 to be charged or discharged based on a control signal of the ECU 30.

The motor 50 drives the electric vehicle 1 based on the control information (for example, torque information) transmitted from the ECU 30 by using electric energy of the battery 10.

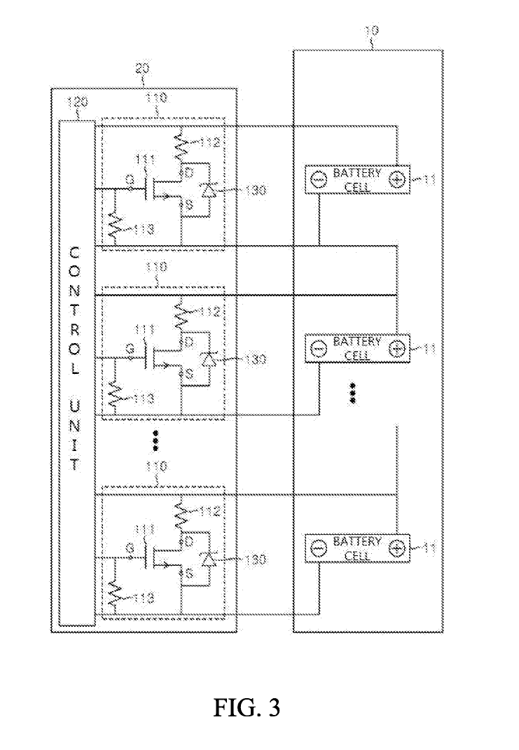

FIG. 2 is a block diagram illustrating a configuration of the battery balancing apparatus according to the exemplary embodiment of the present invention, and FIG. 3 is a diagram illustrating an example of a particular configuration of the battery balancing apparatus according to the exemplary embodiment of the present invention.

Referring to FIGS. 2 and 3, the battery balancing apparatus 100 may include a balancing unit 110, a control unit 120, and a self-discharging unit 130. The battery balancing apparatuses 100 illustrated in FIGS. 1 and 2 are the exemplary embodiment, and constituent elements thereof are not limited to the exemplary embodiment illustrated in FIGS. 2 and 3, and may be added, changed, or deleted as necessary.

The battery balancing apparatus 100 may be included in the battery 10 including battery cells 11, and the BMS 20, which calculates an SOC, an SOH, and a maximum input/output power allowance quantity of the battery cell 11 based on a voltage, a current, and a temperature of each of the battery cells 11, and controls a charge or a discharge of the battery cell 11 by using the calculated state information (the SOC, the SOH, and the maximum input/output power allowance quantity) of the battery cell 11.

The balancing unit 110 may serve to balance a voltage charged in the battery cell 11 included in the battery 10. More particularly, when a voltage value of the battery cell 11 is equal to or larger than a predetermined second reference voltage value, the balancing unit 110 may perform passive balancing of discharging the battery cell 11. To this end, the balancing unit 110 may include a switching element 111 and a balancing resistor 112.

Herein, the switching element 111 may be any one among a metal oxide silicon field effect transistor (MOS FET) device, an insulated gate bipolar transistor (IGBT) device, and a bipolar junction transistor (BJT) device.

When the switching element 111 is the MOS FET device, the balancing unit 110 may further include a gate resistor 113 for adjusting a gate voltage of the MOS FET device, in addition to the balancing resistor 112.

Hereinafter, the balancing unit 110, in which the switching element 111 is the MOS FET device, will be described.

The switching element 111 may include a drain terminal D, a gate terminal G, and a source terminal S, and the drain terminal D and the gate terminal G may be connected to the balancing resistor 112 and the gate resistor 113, respectively.

When a gate voltage of a threshold voltage or larger is applied to the gate terminal G of the switching element 111, the drain terminal D and the source terminal S are electrically conducted, so that a current may flow in the balancing resistor 112 connected with the drain terminal D.

In this case, the current flowing in the balancing resistor 112 may be a current output from the battery cell 11 in order to perform the balancing of the battery cell 11 according to the application of the voltage having the predetermined first reference voltage value or larger to the battery cell 11.

That is, the switching element 111 is electrically conducted and the current output from the battery cell 11 flows in the balancing resistor 112, so that the battery cell 11 is discharged, and thus, the voltage value of the battery cell 11, which is charged with the voltage having the predetermined first reference voltage value or larger, may be decreased.

In the meantime, in order to adjust a gate voltage applied to the gate terminal G in response to the threshold voltage of the switching element 111, a resistance value of the gate resistor 113 may be changed.

The control unit 120 may serve to control an operation of the balancing unit 110 in response to a voltage value of the battery cell 11.

More particularly, when the voltage value of the battery cell 11 is equal to or larger than the predetermined second reference voltage value, the control unit 120 may apply a gate voltage having the threshold voltage or larger of the switching element 111 to the gate terminal G and control an operation state of the switching element 111 to be on. Herein, the predetermined second reference voltage value may be a voltage value serving as a reference for determining whether to perform the balancing of the battery cell 11.

Accordingly, the control unit 120 allows the current to flow in the balancing resistor 112 connected with the drain terminal D of the switching element 111, thereby discharging the battery cell 11.

In contrast to this, when the voltage value of the battery cell 11 is smaller than the predetermined second reference voltage value, the control unit 120 may control an operation state of the switching element 111 to be off and may not discharge the battery cell 11.

In this case, the control unit 120 may be any one of a micro controller unit (MCU) and an application specific integrated circuit (ASIC).

In the meantime, when a communication problem is generated between the control unit 120 and the switching element 111 or an error is generated in the control unit 120 and the control unit 120 is erroneously operated, the switching element 111 may not be switched from off to on even though the voltage value of the battery cell 11 is equal to or larger than the predetermined second reference voltage value.

Further, when the switching element 111 deteriorates, the switching element 111 may not be switched from off to on even though the voltage value of the battery cell 11 is equal to or larger than the predetermined second reference voltage value.

Accordingly, the voltage that is equal to or larger than the predetermined second reference voltage value is charged in the battery cell 11, so that imbalance is generated between the battery cells 11.

When the balancing unit 110 is not operated, the self-discharging unit 130 is connected to the switching element 111 in parallel, so that an inverse voltage of the voltage of the battery cell 11 is applied, and may serve to discharge the battery cell 11 according to whether the voltage of the battery cell 11 exceeds the predetermined first reference voltage value.

More particularly, when the switching element 111 is not operated and is not switched on, and the battery cell 11 is not discharged even though the voltage that is equal to or larger than the predetermined second reference voltage value is charged in the battery cell 11, the self-discharging unit 130 may discharge the battery cell 11 when the voltage value of the battery cell 11 exceeds the predetermined first reference voltage value.

In the contrast to this, when the voltage value of the battery cell 11 is equal to or smaller than the predetermined first reference voltage value, the self-discharging unit 130 may not discharge the battery cell 11.

Herein, the predetermined first reference voltage value may be a voltage value larger than the predetermined second reference voltage value.

In the meantime, the self-discharging unit 130 may be any one of a zener diode and a transient voltage suppression (TVS) diode, and when the self-discharging unit 130 is the zener diode, the predetermined first reference voltage value may be a breakdown voltage value of the zener diode.

A process of discharging the battery cell 11 when the self-discharging unit 130 is the zener diode will be described in detail.

When the switching element 111 is not operated and is not switched on, and the battery cell 11 is not discharged even though the voltage that is equal to or larger than the predetermined second reference voltage value is charged in the battery cell 11, the voltage of the battery cell 11 may be charged with the predetermined first reference voltage value which exceeds the predetermined second reference voltage value.

Accordingly, the voltage of the first reference voltage value exceeding the breakdown voltage value is applied to both ends of the self-discharging unit 130 that is the zener diode, and thus, the zener diode is electrically conducted and a current flows in the balancing resistor 112, thereby discharging the battery cell 11.

Then, the voltage of the battery cell 11 is decreased by the discharging of the battery cell 11, so that the voltage having the predetermined first reference voltage value or smaller may be charged in the battery cell 11.

Accordingly, the voltage of the breakdown voltage value or smaller is applied to both ends of the self-discharging unit 130 that is the zener diode and the zener diode is turned off, so that the discharging of the battery cell 11 may be stopped.

Accordingly, in the battery balancing apparatus 100 according to the present invention, even though the switching element 111 performing the balancing of the battery cell 11 and the control unit 120 controlling the switching element 11 are erroneously operated, when a voltage value of the battery cell 11 exceeds the predetermined first reference voltage value, the battery cell 11 is discharged through the self-discharging unit 130, thereby preventing the battery cell 11 from being overcharged.

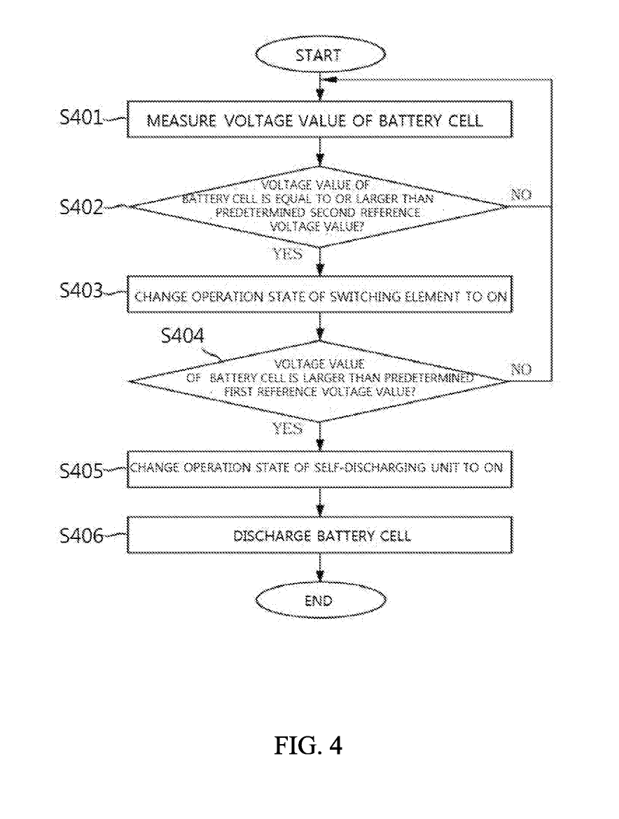

FIG. 4 is a flowchart for describing a battery balancing method according to an exemplary embodiment of the present invention.

Referring to FIG. 4, the BMS measures a voltage applied to a battery cell (S601), and the control unit controls an operation state of the switching element in response to the measured voltage of the battery cell to perform balancing of the battery cell.

More particularly, when a voltage of the battery cell is equal to or larger than a predetermined second reference voltage value (S402), the control unit applies a gate voltage of a threshold voltage or larger of the switching element to a gate terminal and changes an operation state of the switching element to be on (S403). Accordingly, a current flows in the balancing resistor and the battery cell is discharged. In contrast to this, when the voltage of the battery cell is smaller than a predetermined second reference voltage value (S402), the control unit does not change the operation state of the switching element and returns to the start.

In the case where the control unit or the switching element is erroneously operated, when the battery cell is not balanced, that is, not discharged in operations S401 to S403, so that the voltage of the battery cell is increased to a predetermined second reference voltage value or more and exceeds the predetermined first reference voltage value (S404), the operation state of the self-discharging unit that is connected with the switching element in parallel is changed to be on (S405). Accordingly, a current flows in the balancing resistor, so that the battery cell is discharged (S406), and the voltage of the battery cell is decreased to be the predetermined first reference voltage value or smaller.

Accordingly, in the battery balancing method according to the present invention, even though the switching element performing the balancing of the battery cell and the control unit controlling the switching element are erroneously operated, when a voltage value of the battery cell exceeds the predetermined first reference voltage value, the battery cell is discharged through the self-discharging unit, thereby preventing the battery cell from being overcharged.

Although the present invention has been described with reference to the exemplary embodiments, those skilled in the art may understand that the present invention may be variously modified and changed within a scope without departing from the spirit and the area of the present invention described in the accompanying claims.

1. An apparatus for balancing a battery, the apparatus comprising:
a balancing unit which is connected with a battery cell included in a battery and performs balancing of the battery cell;
a control unit which controls an operation of the balancing unit in response to a voltage value of the battery cell; and
a self-discharging unit which discharges the battery cell according to whether a voltage of the battery cell exceeds a predetermined first reference voltage value during a non-operation of the balancing unit.

2. The apparatus of claim 1, wherein the balancing unit includes:
a balancing resistor consuming power of the battery cell; and
a switching element which conducts or blocks a current flowing from the battery cell to the balancing resistor.

3. The apparatus of claim 2, wherein when the voltage value of the battery cell is equal to or larger than a predetermined second reference voltage value, the control unit switches the switching element to be on and allows a current to flow in the balancing resistor to discharge the battery cell.

4. The apparatus of claim 2, wherein the self-discharging unit is connected with the switching element in parallel, so that the voltage of the battery cell is applied as an inverse voltage, and when the switching element is not operated, so that the voltage value of the battery cell exceeds the first reference voltage value, the self-discharging unit electrically conducts the current flowing from the battery cell to the balancing resistor to discharge the battery cell.

5. The apparatus of claim 1, wherein the self-discharging unit is any one of a zener diode and a transient voltage suppression (TVS) diode.

6. The apparatus of claim 5, wherein when the self-discharging unit is the zener diode, the first reference voltage value is a breakdown voltage value of the zener diode.

7. A method of balancing a battery, the method comprising:
providing, which is connected with a battery cell included in a battery to perform balancing of the battery cell;
controlling, by a control unit, an operation of the balancing unit in response to a voltage value of the battery cell; and
discharging, by a self-discharging unit, the battery cell according to whether a voltage value of the battery cell exceeds a predetermined first reference voltage value during a non-operation of the balancing unit.

8. The method of claim 7, wherein the providing includes:
providing a balancing resistor consuming power of the battery cell; and
providing a switching element which conducts or blocks a current flowing from the battery cell to the balancing resistor.

9. The method of claim 8, wherein the controlling includes, when the voltage value of the battery cell is equal to or larger than a predetermined second reference voltage value, switching, by the control unit, the switching element to be on, and allowing a current to flow in the balancing resistor to discharge the battery cell.

10. The method of claim 8, wherein the discharging includes, when the switching element is not operated, so that the voltage value of the battery cell exceeds the first reference voltage value, electrically conducting, by the self-discharging unit, which is connected with the switching element in parallel, so that the voltage of the battery cell is applied as an inverse voltage, the current flowing from the battery cell to the balancing resistor to discharge the battery cell.

11. The method of claim 7, wherein the self-discharging unit is any one of a zener diode and a transient voltage suppression (TVS) diode.

12. The method of claim 11, wherein when the self-discharging unit is the zener diode, the first reference voltage value is a breakdown voltage value of the zener diode.
